(19) United States
(12) Patent Application Publication
(10) Pub. No.: US 2005/0181901 A1
(43) Pub. Date: Aug. 18, 2005

(54) Double action belt tensioner

(76) Inventors: Chang-Hyun Shin, Windsor (CA); John William Potts, Windsor (CA); Dan S. Ursu, Windsor (CA)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/779,057

(22) Filed: Feb. 13, 2004

(51) Int. Cl. F16H 7/12

(52) U.S. Cl. 474/134

(57) ABSTRACT

A belt tensioner comprises first and second pulleys, a main arm and a sub-arm. The first pulley is displacable relative to an engine, and the second pulley is displacable relative to the first pulley. The main arm is connected to the first pulley, and a first spring is connected to the main arm and resists displacement of the first pulley when the engine is started. The sub-arm is connected to the second pulley, and a second spring is connected between the main arm and the sub-arm and maintains the second pulley generally equidistant from the first pulley while the engine is running.

### TECHNICAL FIELD OF THE INVENTION

This invention relates generally to internal combustion engines for motor vehicles, and relates more particularly to a belt tensioner for accessory drives of an internal combustion engine.

### BACKGROUND OF THE INVENTION

Conventional motor vehicles are provided with belts for rotatably connecting various components. In one example, various motor vehicle accessories are powered by a continuous drive belt which is driven by an engine crankshaft through a crankshaft pulley. In another example, a drive belt is used to synchronize engine drive and rotatably connect an engine crankshaft and cam shaft sprockets. Proper vehicle operation requires the maintenance of adequate tension in such drive belts and drive belts.

Tensioners are used to maintain proper tensioning of the drive and drive belts. Conventional tensioners include two types—manual and automatic. Manual accessory belt tensioners require user action to maintain proper tension throughout the life of a belt. Automatic accessory belt tensioners typically are biased into engagement with the belt for maintaining the belt under tension. A typical automatic belt tensioner includes a tension arm pivotally mounted on a hub. A tension pulley is rotatably attached to a free end of the tension arm. A compression coil spring biases the pulley into engagement with the belt to thereby reduce the vibration of the belt by tensioning.

### SUMMARY OF THE INVENTION

One aspect of the present invention is a belt tensioner comprising first and second pulleys, a main arm and a sub-arm. The first pulley is displacable relative to an engine, and the second pulley is displacable relative to the first pulley. The main arm is connected to the first pulley, and a first spring is connected to the main arm and resists displacement of the first pulley when the engine is started. The sub-arm is connected to the second pulley, and a second spring is connected between the main arm and the sub-arm and maintains the second pulley generally equidistant from the first pulley while the engine is running.

In an alternative embodiment, the belt tensioner comprises a main sliding block connected to the first pulley, and at least one first spring connected to the main sliding block and resisting displacement of the first pulley when the engine is started. A sub-sliding block is connected to the second pulley, and at least one second spring is connected between the main sliding block and the sub-sliding block and maintains the second pulley generally equidistant from the first pulley while the engine is running.

Accordingly, it is an object of the present invention to provide a device of the type described above that provides both running tension and starting tension for an accessory belt of a motor vehicle.

Another object of the present invention is to provide a device of the type described above that provides damping against any residual oscillation of the pulleys.

These and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a front view of an accessory drive system including an embodiment of a belt tensioner according to one aspect of the present invention;

FIG. 2 is a perspective view of a the belt tensioner;

FIG. 3 is a side view of the belt tensioner;

FIG. 4 is a front view of the accessory drive system with the belt tensioner in a starting position;

FIG. 5 is a perspective view of a sliding-type belt tensioner; and

FIG. 6 is a front view of the sliding-type belt tensioner.

### DETAILED DESCRIPTION OF THE PRESENTLY PREFERRED EMBODIMENTS

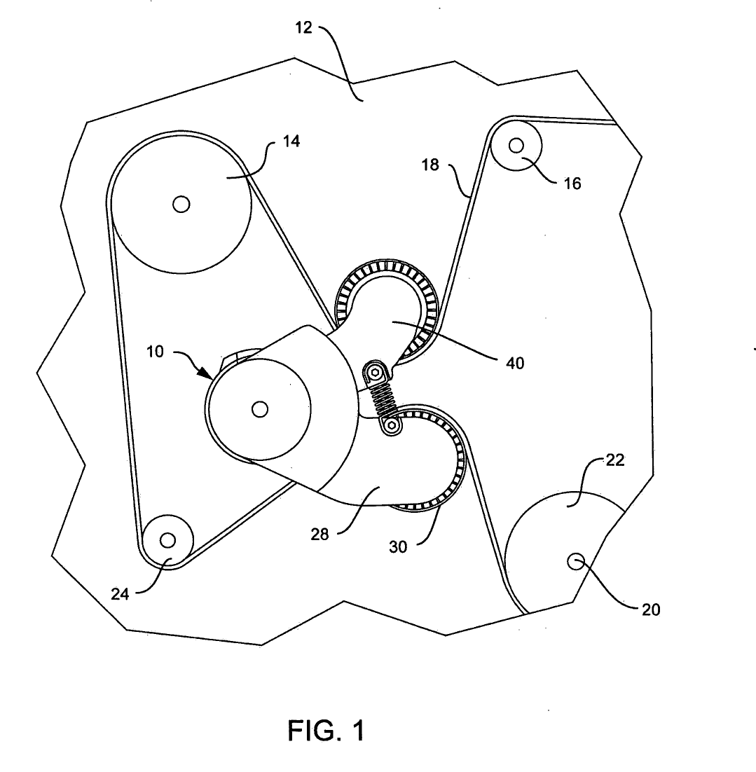

FIG. 1 shows one embodiment 10 of a tensioner according to one aspect of the present invention. The tensioner 10 is operatively incorporated into an accessory device system associated with an engine 12 of a motor vehicle. The accessory device system includes a plurality of rotating accessories 14 and 16, and a continuous drive belt 18. The drive belt 18 is driven during operation by an engine crankshaft 20 through a crankshaft pulley 22. In a conventional manner, the plurality of rotating accessories 14 and 16 may include an alternator/starter 24, an air conditioning compressor, a power steering pump, a water pump and the like. The belt tensioner 10 is generally movable in a clockwise direction as shown for increasing the tension in the drive belt 18, and movable in a counterclockwise direction as shown for decreasing the tension in the drive belt 18.

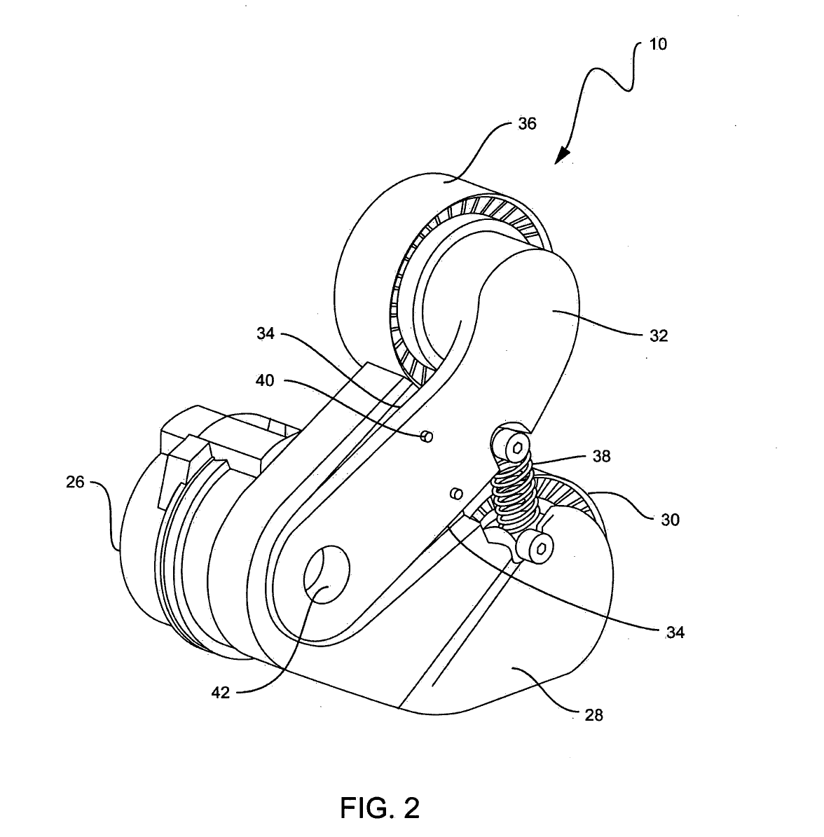

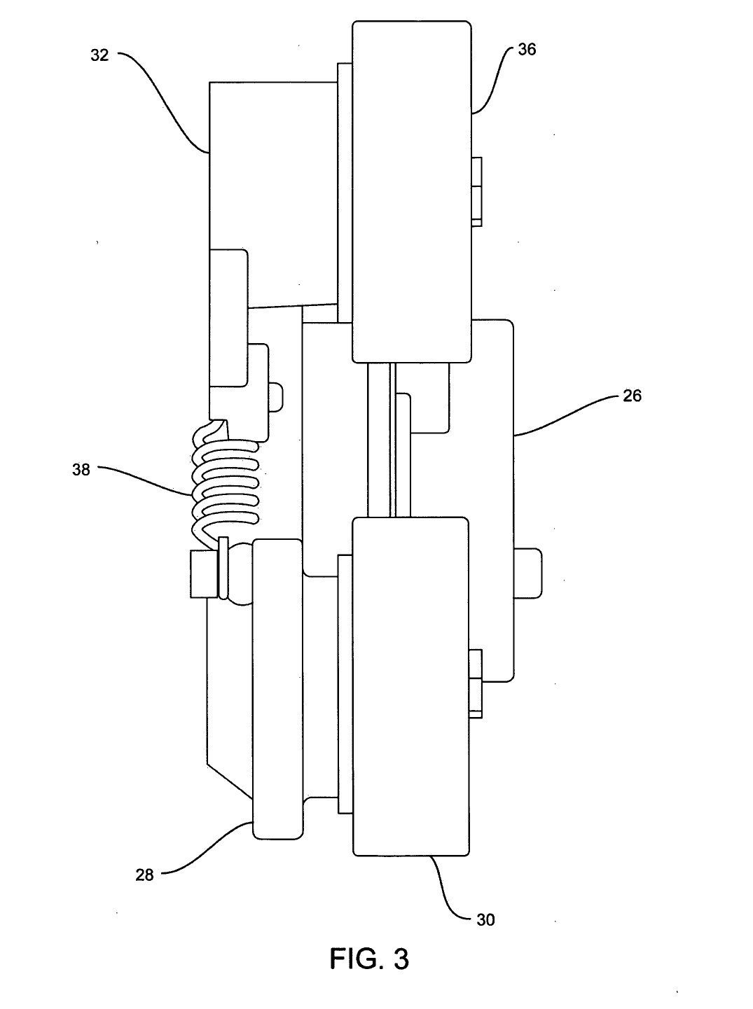

FIGS. 2 and 3 show the tensioner 10 in greater detail. The tensioner 10 includes a clock spring unit 26, a main arm 28, and a pulley 30. The clock spring unit 26 is relatively large displacement, and is fixed to the engine 12. The main arm 28 is disposed adjacent the clock spring unit 26, and the pulley 30 is rotatably mounted on the distal end of the main arm. A sub-arm 32 is situated adjacent the main arm 28, and is rotatable within a recess 34 in the main arm. A bushing (not shown) of polymeric or other suitable material may be disposed between the main arm 28 and the sub-arm 32 to facilitate their relative rotation. In a preferred embodiment, the sub-arm 32 is free to rotate within the recess 34 in the main arm in the range of about five degrees.

A pulley 36 is rotatably mounted on the distal end of the sub-arm 32 in a manner similar to the mounting of the pulley 30 on the main arm 28. A relatively small displacement spring, preferably such as a coil spring 38, is connected between the sub-arm 32 and the main arm 28. One or more forced contact embossments 40 may be applied on both sides of the sub-arm 32. On one side of the sub-arm 32, the embossments 40 ride against the main arm 28. On the opposite side of the sub-arm 32, the embossments 40 ride against a cover (not shown). The belt tensioner 10 is preferably attached to the engine 12 by a bolt (not shown) extending through a hole 42 in the sub-arm 32, through similar holes in the main arm 28 and in the clock spring unit 26, and into a block of the engine 12. Various covers may also be provided for the tensioner 10.

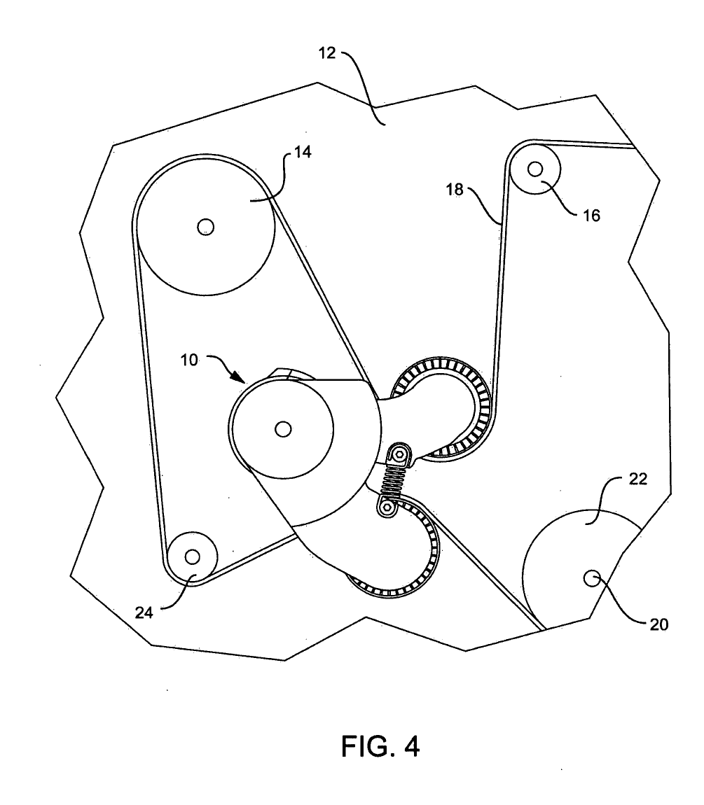

While the engine 12 is operating normally or at rest, the spring 38 biases the sub-arm 32 toward the main arm 28, and thereby maintains running tension in the drive belt 18. FIG. 4 shows the accessory device system upon engagement of the alternator/starter 24. Application of the alternator/starter 24 in the clockwise direction as shown develops tension in the drive belt 18 between the alternator/starter and the crankshaft pulley 22. At least initially, this force tends to shorten that length of drive belt and exert a downward force on the lower pulley 30 of the main arm 28. Downward movement of the lower pulley 30 in turn induces rotation of the tensioner 10 that is resisted by the clock spring unit 26. The embossments 40 guide the travel of the sub-arm 32, and damp any oscillation of the pulleys 30 and 32 due to the residual spring force.

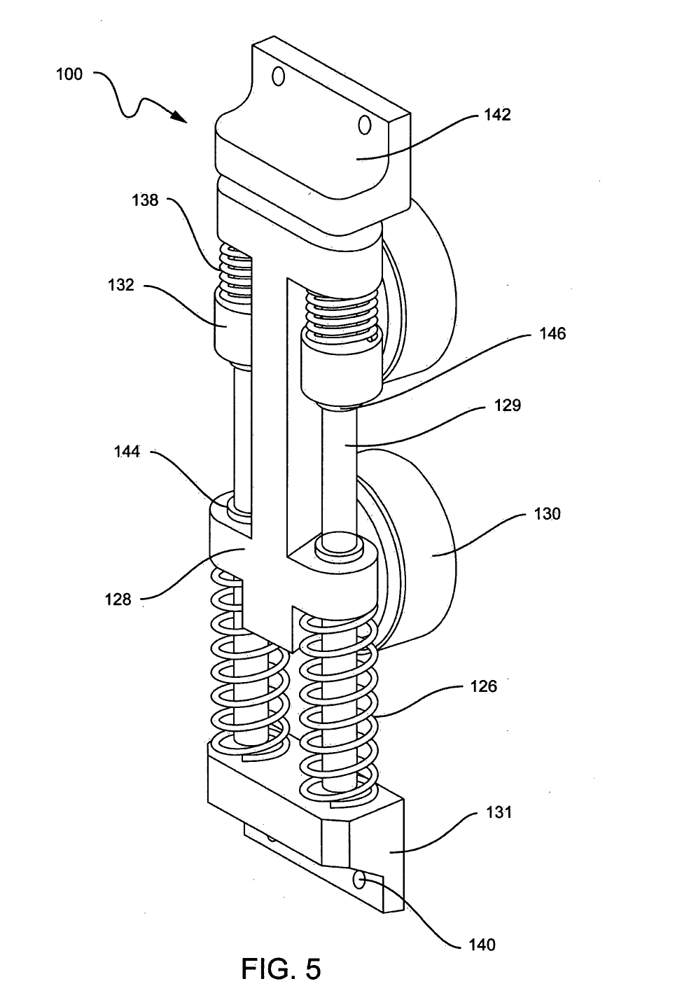

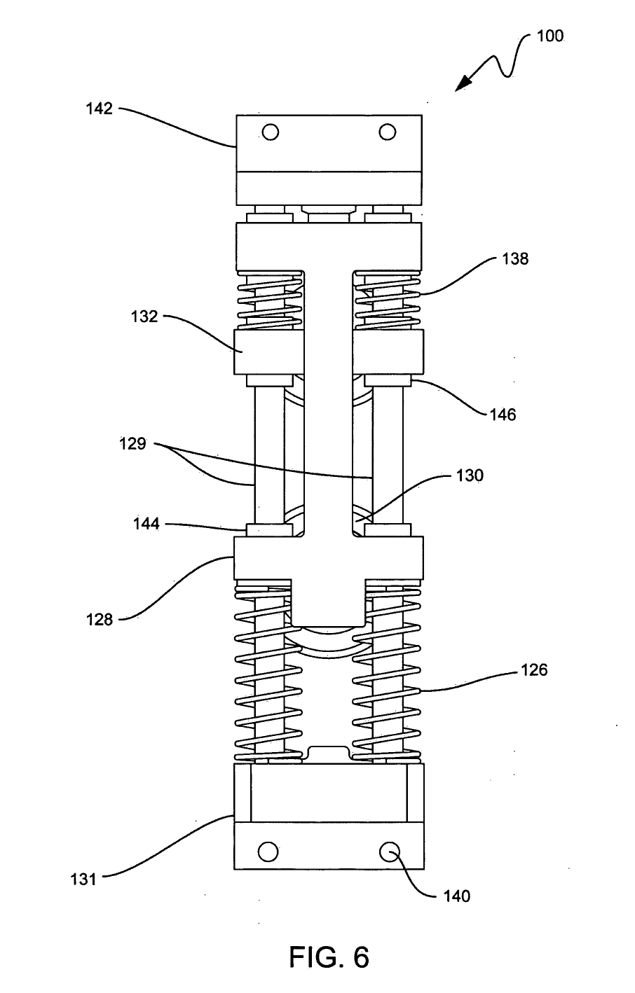

FIGS. 5 and 6 show an alternative embodiment 100 of the tensioner. The tensioner 100 includes a pair of relatively large displacement main sliding block springs 126, a main sliding block 128, and a pulley 130. The main sliding block 128 is slidably mounted on a pair of sliding guides 129. The main sliding block springs 126 are disposed around the sliding guides 129 between the underside of the main sliding block 128 and a lower end block 131, and the pulley 130 is rotatably mounted on the main sliding block. A sub-sliding block 132 is also slidably mounted on the sliding guides 129, and includes a pulley 136 rotatably mounted thereon. A biasing mechanism such as a pair of relatively small displacement springs 138 are disposed around the sliding guides 129 and between the upper side of the sub-sliding block 132 and an upper portion of the main sliding block 128. The belt tensioner 100 is preferably attached to the engine 12 by a bolts (not shown) extending through a pair of holes 140 in the lower end block 131, through similar holes in an upper end block 142, and into some relatively fixed location such as a timing chain cover of the engine block. Various covers may also be provided for the tensioner 100.

While the engine 12 is operating normally or at rest, the springs 126 and 138 bias the sub-sliding block 132 toward the main sliding block 128, to the position shown in the figures, to thereby maintain running tension in the drive belt. Engagement of the alternator/starter develops tension in the drive belt, and at least initially this force tends to shorten that length of drive belt and exert a downward force on the lower pulley 130 of the main sliding block 128. Downward movement of the lower pulley 130 pulls the sub-sliding block 132 downwardly through the springs 138, and is resisted by the main sliding block springs 126. Any residual oscillation of the pulleys 130 and 132 may be damped by forced contact between linear bearings 144 and 146 and their respective sliding guide.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

1. A belt tensioner for an internal combustion engine of a motor vehicle, the belt tensioner comprising:
a first pulley displacable relative to the engine;
a second pulley displacable relative to the first pulley;
means for resisting displacement of the first pulley when the engine is started; and
means for maintaining the second pulley generally equidistant from the first pulley while the engine is running.

2. The belt tensioner of claim 1 wherein the means for resisting displacement of the first pulley comprises a main arm connected to the first pulley, and a sub-arm connected to the second pulley.

3. The belt tensioner of claim 2 wherein the means for resisting displacement of the first pulley further comprises a first spring connected to the main arm.

4. The belt tensioner of claim 3 wherein the first spring comprises a clock spring.

5. The belt tensioner of claim 1 wherein the means for maintaining comprises a main arm connected to the first pulley, and a sub-arm connected to the second pulley.

6. The belt tensioner of claim 5 wherein the means for maintaining comprises a second spring connected between the main arm and the sub-arm.

7. The belt tensioner of claim 6 wherein the second spring comprises a coil spring.

8. The belt tensioner of claim 1 wherein the means for resisting displacement of the first pulley comprises a main sliding block connected to the first pulley, and a sub-sliding block connected to the second pulley.

9. The belt tensioner of claim 8 wherein the means for resisting displacement of the first pulley comprises at least one first spring connected to the main sliding block.

10. The belt tensioner of claim 9 wherein the at least one first spring comprises a coil spring.

11. The belt tensioner of claim 1 wherein the means for maintaining comprises a main sliding block connected to the first pulley, and a sub-sliding block connected to the second pulley.

12. The belt tensioner of claim 11 wherein the means for maintaining comprises at least one second spring connected between the main sliding block and the sub-sliding block.

13. The belt tensioner of claim 12 wherein the at least one second spring comprises a coil spring.

14. A belt tensioner for an internal combustion engine, the belt tensioner comprising:
a first pulley displacable relative to the engine;
a second pulley displacable relative to the first pulley;
a main arm connected to the first pulley;
a first spring connected to the main arm and resisting displacement of the first pulley when the engine is started;
a sub-arm connected to the second pulley; and
a second spring connected between the main arm and the sub-arm and maintaining the second pulley generally equidistant from the first pulley while the engine is running.

15. The belt tensioner of claim 14 wherein the first spring comprises a clock spring.

16. The belt tensioner of claim 14 wherein the second spring comprises a coil spring.

17. A belt tensioner for an internal combustion engine, the belt tensioner comprising:
a first pulley displacable relative to the engine;
a second pulley displacable relative to the first pulley;
a main sliding block connected to the first pulley;
at least one first spring connected to the main sliding block and resisting displacement of the first pulley when the engine is started;
a sub-sliding block connected to the second pulley; and
at least one second spring connected between the main sliding block and the sub-sliding block and maintaining the second pulley generally equidistant from the first pulley while the engine is running.

18. The belt tensioner of claim 17 wherein the at least one first spring comprises a coil spring.

19. The belt tensioner of claim 17 wherein the at least one second spring comprises a coil spring.
